(19) United States
(12) Patent Application Publication
(10) Pub. No.: US 2026/0032591 A1
(43) Pub. Date: Jan. 29, 2026

(54) METHOD, DEVICE AND COMPUTER STORAGE MEDIUM OF COMMUNICATION

(71) Applicant: NEC Corporation, Tokyo (JP)

(72) Inventors: Gang WANG, Beijing (CN); Lei CHEN, Beijing (CN); Zonghui XIE, Beijing (CN)

(73) Assignee: NEC Corporation, Tokyo (JP)

(21) Appl. No.: 18/996,172

(22) PCT Filed: Jul. 19, 2022
(86) PCT No.: PCT/CN2022/106528

§ 371 Date: Jan. 17, 2025

(51) Int. Cl. H04W 52/02; H04W 74/0833; H04W 76/38

(52) U.S. Cl. CPC H04W 52/0235; H04W 74/0833; H04W 76/38

(57) ABSTRACT

Embodiments of the present disclosure relate to methods, devices and computer readable media of communication. A terminal device determines whether to apply a low power mode during which a wake-up signal monitoring is performed. Based on a determination of applying the low power mode, the terminal device performs an operation associated with the low power mode. In this way, notification of a transition of a LP mode may be achieved.

### TECHNICAL FIELD

Embodiments of the present disclosure generally relate to the field of telecommunication, and in particular, to methods, devices and computer storage media of communication for a low power mode during which a wake-up signal (WUS) monitoring is performed.

### BACKGROUND

Currently, it has been proposed to use main radio to describe a regular communication device performing normal radio resource control (RRC) states and additionally design a wake-up signal (WUS) receiver to monitor a WUS for turn-on of the main radio. When a terminal device is not receiving a service, the terminal device may enter a low power (LP) mode during which a WUS monitoring is performed, for example, the main radio is switched off and the WUS receiver is switched on to monitor the WUS. However, it is still unclear how to notify a transition of the LP mode.

### SUMMARY

In general, embodiments of the present disclosure provide methods, devices and computer storage media of communication for notification of a transition of a LP mode.

In a first aspect, there is provided a method of communication. The method comprises: determining, at a terminal device, whether to apply a low power mode during which a wake-up signal monitoring is performed; and performing, based on a determination of applying the low power mode, an operation associated with the low power mode.

In a second aspect, there is provided a method of communication. The method comprises: determining, at a terminal device, whether to apply a low power mode during which a wake-up signal monitoring is performed; and transmitting, based on a determination of applying the low power mode, a request for applying the low power mode.

In a third aspect, there is provided a method of communication. The method comprises: transmitting, at a network device, information of applying a low power mode during which a wake-up signal monitoring is performed.

In a fourth aspect, there is provided a method of communication. The method comprises: receiving, at a network device, a request for applying a low power mode during which main radio of a terminal device is turned off and a wake-up signal receiver of the terminal device is turned on.

In a fifth aspect, there is provided a device of communication. The device comprises a processor configured to cause the device to perform the method according to any of the first to fourth aspects of the present disclosure.

In a sixth aspect, there is provided a computer readable medium having instructions stored thereon. The instructions, when executed on at least one processor, cause the at least one processor to perform the method according to any of the first to fourth aspects of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication network in which some embodiments of the present disclosure can be implemented;

FIG. 1B illustrates an example structure of a terminal device in which some embodiments of the present disclosure can be implemented;

FIG. 1C illustrates a diagram illustrating a LP WUS mechanism in which some embodiments of the present disclosure can be implemented;

FIG. 2 illustrates a schematic diagram illustrating a process of communication according to embodiments of the present disclosure;

FIG. 3A illustrates a schematic diagram of a time window for a low power control channel (LPCCH) according to embodiments of the present disclosure;

FIG. 3B illustrates a schematic diagram of LPCCH scheduling according to embodiments of the present disclosure;

FIG. 4 illustrates a schematic diagram illustrating another process of communication according to embodiments of the present disclosure;

FIG. 5 illustrates an example method of communication implemented at a terminal device in accordance with some embodiments of the present disclosure;

FIG. 6 illustrates another example method of communication implemented at a terminal device in accordance with some embodiments of the present disclosure;

FIG. 7 illustrates an example method of communication implemented at a network device in accordance with some embodiments of the present disclosure;

FIG. 8 illustrates another example method of communication implemented at a network device in accordance with some embodiments of the present disclosure; and

FIG. 9 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporate one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present disclosure, the term “a connected state” may be interchangeably used with “a RRC_CONNECTED state”, the term “an idle state” may be interchangeably used with “a RRC_IDLE state”, and the term “an inactive state” may be interchangeably used with “a RRC_INACTIVE state”.

In the context of the present disclosure, the term “a LP mode” may be interchangeably used with “a LP WUS mode” or “a LP WUS mechanism” or any other suitable terms having similar functionalities. The term “a WUS” may be interchangeably used with “a LP WUS” or any other suitable terms having similar functionalities. The term “LPCCH” may be interchangeably used with any other suitable terms having similar functionalities.

In the context of the present disclosure, the term “apply a LP mode” may refer to at least one of the following:
1. Switch off the main radio and switch on the LP-WUS receiver;
2. Stop performing the actions related to RRC_IDLE/INACTIVE, e.g. reception of SSB, SI, paging;
3. exit RRC_IDLE/INACTIVE/CONNECTED and enter LP-WUS state; or
4. Apply LP-WUS related configuration and monitor LP-WUS signal.

In general, the fifth generation (5G) devices consume tens of milliwatts in RRC idle or inactive state and hundreds of milliwatts in RRC connected state. Designing to prolong battery life is a necessity for improving energy efficiency as well as for better user experience.

To meet the battery life requirements, an enhanced discontinuous reception (eDRX) cycle with a large value is expected to be used. The eDRX cycle may result in high latency and thus is not suitable for services with requirements of both long battery life and low latency. For example, in fire detection and extinguishment use case, a long eDRX cycle cannot meet the delay requirements. That is, eDRX is apparently not suitable for latency-critical use cases. Thus, it is expected to study an ultra-low power mechanism that can support low latency, e.g., lower than eDRX latency. Further, it is expected to study and evaluate Layer 1 (L1) procedures and higher layer protocol changes needed to support WUSs.

As mentioned above, a LP mode is proposed during which a WUS monitoring is performed. For example, during the LP mode, main radio is switched off and a WUS receiver is switched on to monitor a WUS for turn-on of main radio. However, it is still unclear how to notify a transition of a LP mode. For example, it is unclear how a network informs a terminal device or a terminal device informs a network of applying the LP mode.

In view of this, embodiments of the present disclosure provide solutions of communication so as to overcome the above and other potential issues. In one aspect, a terminal device determines whether to apply the LP mode. Based on a determination of applying the LP mode, the terminal device may perform an operation associated with the LP mode. In this way, a network may trigger a terminal device applying a LP mode.

In another aspect, a terminal device determines whether to apply the LP mode. Based on a determination of applying the LP mode, the terminal device may transmit a request for applying the LP mode. In this way, a terminal device may request a network for applying a LP mode.

Principles and implementations of the present disclosure will be described in detail below with reference to the figures.

### Example of Communication Network

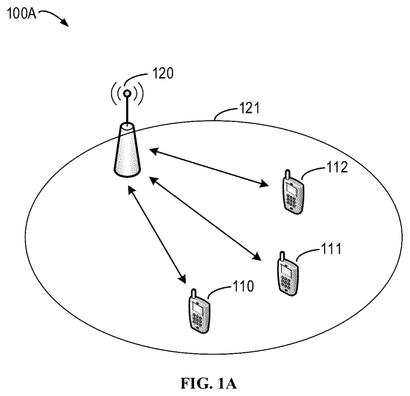

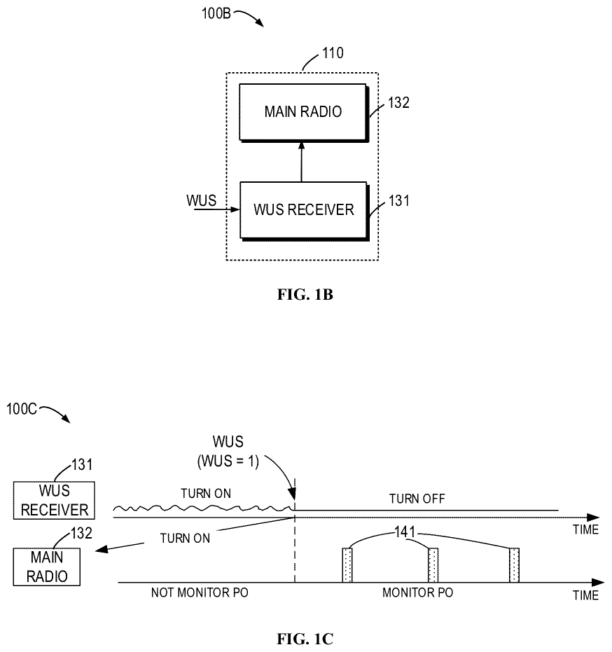

FIG. 1A illustrates a schematic diagram of an example communication network 100A in which some embodiments of the present disclosure can be implemented. As shown in FIG. 1A, the communication network 100A may include terminal devices 110, 111 and 112 and a network device 120. In some embodiments, the network device 120 may provide a serving cell (also referred to as a cell herein) 121 to serve one or more terminal devices. In this example, the terminal devices 110, 111 and 112 are shown as being located in the cell 121 and served by the network device 120.

It is to be understood that the number of devices or cells in FIG. 1A is given for the purpose of illustration without suggesting any limitations to the present disclosure. The communication network 100A may include any suitable number of network devices and/or terminal devices and/cells adapted for implementing implementations of the present disclosure.

As shown in FIG. 1A, each of the terminal devices 110, 111 and 112 may communicate with the network device 120 via a channel such as a wireless communication channel. The communications in the communication network 100A may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

FIG. 1B illustrates a diagram 100B illustrating a terminal device in which some embodiments of the present disclosure can be implemented. For convenience, FIG. 1B is described in connection with the terminal device 110 of FIG. 1A. It is to be understood that the terminal device 111 and 112 may also have such structure 100B.

As shown in FIG. 1B, the terminal device 110 may comprise a WUS receiver 131 and main radio 132. The WUS receiver 131 is configured to monitor a WUS. The main radio 132 is configured as a regular communication device performing normal radio resource control (RRC) states. In some embodiments, the WUS receiver 131 and the main radio 132 may be implemented in a same physical entity. In some embodiments, the WUS receiver 131 and the main radio 132 may be implemented in separate physical entities.

In some embodiments, the WUS receiver 131 may detect the WUS indicating turn-off of the main radio 132, and trigger the main radio 132 to enter a turn-off or deep-sleep state. In the turn-off or deep-sleep state, the terminal device 110 is not required to process a RRC idle or inactive or connected state procedure. In some embodiments, the WUS receiver 131 may detect the WUS indicating turn-on of the main radio 132, and trigger the main radio 132 to enter a turn-on state. In the turn-on state, the main radio 132 may monitor paging occasions (POs). More details will be described in connection with FIG. 1C below.

FIG. 1C illustrates a diagram 100C illustrating a LP WUS mechanism in which some embodiments of the present disclosure can be implemented. For convenience, FIG. 1C is described in connection with FIG. 1B. As shown in FIG. 1C, when the terminal device 110 enters a LP mode, the WUS receiver 131 may turn on and the main radio 132 may not monitor POs. When the WUS receiver 131 detects a WUS (for example, WUS=1) indicating turn-on of the main radio 132, the WUS receiver 131 triggers the main radio 132 to turn on and the WUS receiver 131 turns off. In this case, the main radio 132 may start monitoring POs 141.

Compared with an eDRX mechanism, a LP WUS mechanism may reduce both power consumption and latency. Although a WUS receiver is turned on in a LP mode, power consumption in the LP mode may be 100 times less than main radio as the WUS receiver only receive a simple signal (e.g., OOK).

A network may need to trigger a terminal device to apply the LP mode. A terminal device in an idle state, an inactive state or a connected state may possibly apply the LP mode. However, the network cannot reach to a terminal device in an idle or inactive state by per-UE signal.

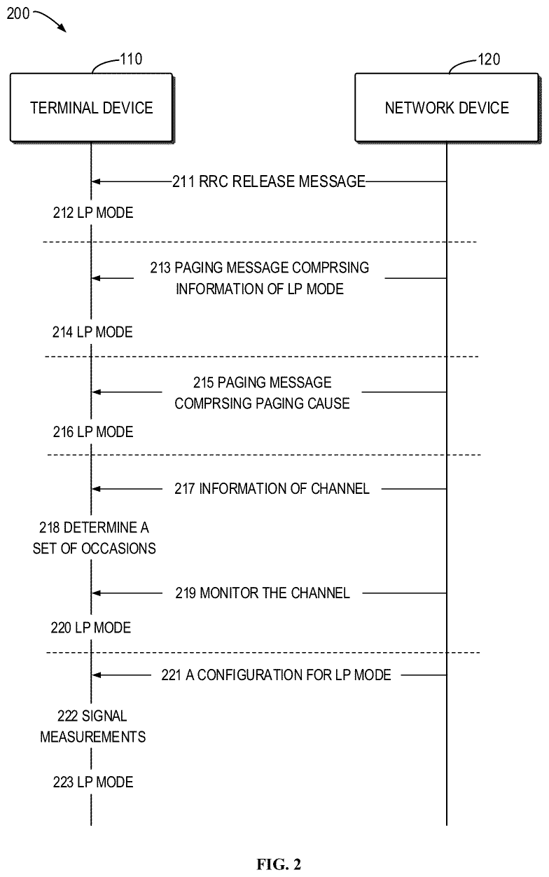

In view of this, embodiments of the present disclosure provide solutions of communication for notification of a transition of a LP mode. The detailed description will be made with reference to FIGS. 2 to 4 below.

### Example Implementation of Network Notification of LP Mode

In some embodiments, the terminal device 110 determines whether to apply a LP mode during which a WUS monitoring is performed. In some embodiments, the terminal device 110 may determine to apply the LP mode based on reception of an indication from the network device 120. In some embodiments, the terminal device 110 may determine to apply the LP mode based on signal measurements.

If the terminal device 110 determines to apply the LP mode, the terminal device 110 performs an operation associated with the LP mode. In some embodiments, the terminal device 110 may switch off the main radio 132. In some embodiments, the terminal device 110 may switch on the WUS receiver 131. In some embodiments, the terminal device 110 may indicate, from a lower layer to upper layers of the terminal device 110, a cause of applying the low power mode. In some embodiments, the terminal device 110 may stop performing an operation in an idle or inactive state. For example, the terminal device 110 may stop receiving at least one of a synchronization signal block (SSB), system information (SI) or a paging message. In some embodiments, the terminal device 110 may apply a configuration for the low power mode. In some embodiments, the terminal device 110 may perform a WUS monitoring. It is to be understood that the operation associated with the LP mode may comprise any combination of the above operations and any other suitable operations.

For illustration, some example embodiments will be described below in connection with Embodiments 1 to 5 and FIG. 2. FIG. 2 illustrates a schematic diagram illustrating a process 200 of communication according to embodiments of the present disclosure. For the purpose of discussion, the process 200 will be described with reference to FIG. 1A. The process 200 may involve the terminal device 110 and the network device 120 as illustrated in FIG. 1A. It is to be understood that the steps and the order of the steps in FIG. 2 are merely for illustration, and not for limitation. For example, the order of the steps may be changed. Some of the steps may be omitted or any other suitable additional steps may be added.

### Embodiment 1

In this embodiment, information of the LP mode may be introduced into a RRC release message. In this way, a network may inform a terminal device in a connected state of applying the LP mode.

With reference to FIG. 2, in some embodiments, the network device 120 may transmit 211 to the terminal device 110, a RRC release message comprising information (for convenience, also referred to as first information herein) of a LP mode. In some embodiments, the information of the LP mode may comprise an indication of the LP mode. The indication of the LP mode may be carried out in any suitable ways.

In some embodiments, the information of the LP mode may comprise a configuration for the LP mode. In some embodiments, the configuration for the LP mode may comprise a time domain configuration indicating where the terminal device 110 should monitor a LP WUS from a time domain view. In some embodiments, the configuration for the LP mode may comprise a frequency domain configuration indicating where the terminal device 110 should monitor a LP WUS from a frequency domain view. In some embodiments, the configuration for the LP mode may comprise a LP WUS sequence configuration indicating a LP WUS pattern. In some embodiments, the configuration for the LP mode may comprise a LP WUS group configuration indicating which LP WUS UE group the terminal device 110 should monitor. It is to be understood that the configuration for the LP mode may comprise any combination of the above configurations and any other suitable configurations.

In some embodiments, the information of the LP mode may comprise a timer for the LP mode. It is to be understood that the information of the LP mode may comprise any combination of the above information and any other suitable information.

For example, a RRC release message may be configured as below.

| | |
|---|---|
| RRCRelease-IEs ::= | SEQUENCE { [symbol] |
| redirectedCarrierInfo | RedirectedCarrierInfo |
| cellReselectionPriorities | CellReselectionPriorities |
| suspendConfig | SuspendConfig |
| deprioritisationReq | SEQUENCE { |
| deprioritizationType | ENUMERATED {frequency, n [symbol] }, |
| deprioritizationTimer | ENUMERATED {min5, min10, min15, min30} |

},

| | |
|---|---|
| indicationLP-WUS | IndicationLP-WUS [symbol] |
| lateNonCriticalExtension | OCTET STRING |
| nonCriticalExtension | RRCRelease-v1540-IEs |

}

[symbol]

| | |
|---|---|
| IndicationLP-WUS ::= | SEQUENCE { [symbol] |
| timeDomainConfig | [symbol] |
| frequencyDomainConfig | [symbol] |
| sequenceConfig | [symbol] |
| groupConfig | [symbol] |

} [symbol] [symbol]
indicates data missing or illegible when filed

In this example, an information element (IE) “indicationLP-WUS” is comprised in the RRC release message. The IE “indicationLP-WUS” comprises a time domain configuration (timeDomainConfig), a frequency domain configuration (frequencyDomainConfig), a LP-WUS sequence configuration (sequenceConfig) and a LP WUS group configuration (groupConfig).

In another example, a RRC release message may be configured as below.

| | |
|---|---|
| RRCRelease-IEs ::= | SEQUENCE { [symbol] |
| redirectedCarrierInfo | RedirectedCarrierInfo |
| cellReselectionPriorities | CellReselectionPriorities |
| suspendConfig | SuspendConfig |
| deprioritisationReq | SEQUENCE { [symbol] |
| deprioritisationType | ENUMERATED {frequency, nr}, |
| deprioritisationTimer | ENUMERATED {min5, min10, min15, min30} |

}

[symbol]

| | |
|---|---|
| indicationLP-WUS | IndicationLP-WUS, |
| lateNonCriticalExtension | OCTET STRING |
| nonCriticalExtension | R [symbol] CRelease-v1540-IEs |

}

[symbol]

[symbol]

| | |
|---|---|
| IndicationLP-WUS ::= | SEQUENCE { [symbol] |
| [symbol] p-wusTimer | ENUMERATED {min5, min10, min15, min30, [symbol] } [symbol] |
| timeDomainConfig | [symbol] |
| frequencyDomainConfig | [symbol] |
| sequenceConfig | [symbol] |
| groupConfig | [symbol] |

[symbol]

[symbol]

indicates data missing or illegible when filed

In this example, an IE “indicationLP-WUS” is comprised in the RRC release message. The IE “indicationLP-WUS” comprises a timer for a LP mode (lp-wus Timer), a time domain configuration (timeDomainConfig), a frequency domain configuration (frequencyDomainConfig), a LP-WUS sequence configuration (sequenceConfig) and a LP WUS group configuration (groupConfig).

It is to be understood that the above RRC release messages are merely examples, and are not intended for limitation.

Upon reception of the RRC release message comprising the information of the LP mode, the terminal device 110 may determine to apply the LP mode. In some embodiments, if the RRC release message is received, the terminal device 110 may start the timer. If the timer expires, the terminal device 110 may determine to apply the LP mode.

In some embodiments where the terminal device 110 supports mobility in the low power mode, if a condition for cell re-selection is fulfilled while the timer is running, the terminal device 110 may restart the timer. In some embodiments, if the terminal device 110 performs a small data transmission (SDT) procedure and the timer is running, the terminal device 110 may restart the timer. In some embodiments, if the terminal device 110 receives a multicast and broadcast service (MBS) and the timer is running, the terminal device 110 may restart the timer.

In some embodiments where the terminal device 110 does not support mobility in the low power mode, if a condition for cell re-selection is fulfilled while the timer is running, the terminal device 110 may stop the timer. In some embodiments, if the terminal device 110 enters a connected state and the timer is running, the terminal device 110 may stop the timer.

Upon determination of applying the LP mode, the terminal device 110 may perform 212 an operation associated with the LP mode. In some embodiments, the terminal device 110 may indicate a release cause “apply LP mode” from a RRC layer to a non-access stratum (NAS) layer. It is to be understood that the release cause may adopt any other forms having similar functionalities.

In some embodiments where the terminal device 110 enters the LP mode, the terminal device 110 may switch off the main radio 132. In some embodiments, the terminal device 110 may switch on the WUS receiver 131. In some embodiments, the terminal device 110 may stop performing an operation in an idle or inactive state. For example, the terminal device 110 may stop receiving at least one of a SSB, SI or a paging message. In some embodiments, the terminal device 110 may apply a configuration for the low power mode. In some embodiments, the terminal device 110 may perform a WUS monitoring. It is to be understood that the operation associated with the LP mode may comprise any combination of the above operations and any other suitable operations.

For illustration, an example procedure may be described as below.

Upon reception of the RRCRelease, the UE shall:
1> if the RRCRelease includes IndicationLP-WUS:
   2> if the LP-WUS timer is included:
      3> start the timer with the timer value set to lp-wusTimer; (now UE will perform actions related to RRC_IDLE/INACTIVE)
   2> else:
      3> indicate the cause “apply LP-WUS” (if support) to upper layers (i.e. UE NAS);
      3> (optionally) stop performing the actions related to RRC_IDLE/INACTIVE (e.g. reception of SSB, SI, paging);
      3> apply the received LP-WUS related configuration for the LP-WUS monitoring;
      3> monitor LP-WUS signal;

The UE shall continue cell re-selection related measurement as well as cell re-selection evaluation when the LP-WUS timer is running.
1> if the conditions for cell re-selection are fulfilled when the LP-WUS timer is running:
   (option1 for LP-WUS mobility capable UE)
   2> restart the LP-WUS timer;
   (option 2 for non LP-WUS mobility capable UE)
   2> stop the LP-WUS timer.

For example, another example procedure may be described as below.
The UE shall:
1> if the LP-WUS timer expires:
   2> indicate the cause “apply LP-WUS” (if support) to upper layers (i.e. UE NAS);
   2> (optionally) stop performing the actions related to RRC_IDLE/INACTIVE (e.g. reception of SSB, SI, paging);
   2> apply the received LP-WUS related configuration for the LP-WUS monitoring;
   2> monitor LP-WUS signal.

For example, another example procedure may be described as below.
When UE enters RRC_CONNECTED, the UE shall stop the LP-WUS timer if running.
When UE performs SDT procedure, the UE shall restart the LP-WUS timer if running.
When UE receives MBS session, the UE shall restart the LP-WUS timer if running.

### Embodiment 2

In this embodiment, information of the LP mode may be introduced into a paging message. In this way, a network may inform a terminal device in an idle or inactive state of applying the LP mode.

Continue to refer to FIG. 2, in some embodiments, the network device 120 may transmit 213, to the terminal device 110, a paging message comprising information (for convenience, also referred to as second information herein) of a LP mode. In some embodiments, the information of the LP mode may comprise a set of identities of terminal devices. It is to be understood that the information of the LP mode may comprise any other suitable information.

In some embodiments, an identity in the set of identities may be a radio network temporary identifier (RNTI). For example, an inactive-radio network temporary identifier (I-RNTI) or any other suitable forms of RNTI. In some embodiments, an identity in the set of identities may be a temporary mobile station identifier (TMSI). For example, a 5G-S-TMSI or any other suitable forms of TMSI. It is to be understood that the identity may adopt any other suitable forms.

For illustration, an example paging message may be configured as below.

| Paging ::= | SEQUENCE { [symbol] |
|---|---|
| pagingRecordList | PagingRecordList |
| lateNonCriticalExtension | OCTET STRING |
| nonCriticalExtension | Paging-v1700-IEs, |
| nonCriticalExtension | Paging-v1800-IEs |
| } [symbol] | |
| [symbol] | |
| Paging-v1 [symbol] 00-IEs ::= | SEQUENCE { [symbol] |
| pagingNotificationList | [symbol] |
| } [symbol] | |
| [symbol] | |
| [symbol] | SEQUENCE [symbol] |
| [symbol] | |
| PagingNotification ::= | SEQUENCE { [symbol] |
| [symbol] ue-Identity | [symbol] |
| [symbol] | |
| [symbol] | |
| [symbol] | |
| [symbol] -Identity ::= | CHOICE [symbol] |
| [symbol] | [symbol] |
| [symbol] | [symbol] |

[symbol]

[symbol]

[symbol]

indicates data missing or illegible when filed

In this example, the paging message comprises an IE “Paging-v1800-IEs” and the IE “Paging-v1800-IEs” comprises an IE “PagingNotificationList”. The IE “PagingNotificationList” comprises a UE identity “PagingUE-Identity”. It is to be understood that this paging message is merely an example, and is not intended for limitation.

In some embodiments, the network device 120 may also transmit, to the terminal device 110, downlink control information (DCI) scheduling reception of the paging message and only comprising an indication of the LP mode. In other words, a configuration for a short message indicator may be introduced in paging DCI. For example, an example short message indicator may be configured as shown in Table 1.

TABLE 1

| Bit Field | Short Message Indicator |
|---|---|
| 00 | Only LP-WUS information for paging is present in the DCI |
| 01 | Only scheduling information for Paging is present in the DCI |
| 10 | Only short message is present in the DCI |
| 11 | At least two types of the above message are present in |
| | the DCI |

In this example, the bit field “00” in the short message indicator may be used to denote there is only information of the LP mode in the paging DCI.

Upon reception of the paging message comprising the information of the LP mode, if an identity in the paging message (e.g., in the IE “PagingNotificationList”) matches an identity of the terminal device 110, the terminal device 110 may determine to apply the LP mode. Upon determination of applying the LP mode, the terminal device 110 may perform 214 an operation associated with the LP mode. In some embodiments, the terminal device 110 may indicate a paging cause “apply LP mode” from a RRC layer to a NAS layer. It is to be understood that the paging cause may adopt any other forms having similar functionalities.

In some embodiments where the terminal device 110 enters the LP mode, the terminal device 110 may switch off the main radio 132. In some embodiments, the terminal device 110 may switch on the WUS receiver 131. In some embodiments, the terminal device 110 may stop performing an operation in an idle or inactive state. For example, the terminal device 110 may stop receiving at least one of a SSB, SI or a paging message. In some embodiments, the terminal device 110 may apply a configuration for the low power mode. In some embodiments, the terminal device 110 may perform a WUS monitoring. It is to be understood that the operation associated with the LP mode may comprise any combination of the above operations and any other suitable operations.

For illustration, an example procedure may be described as below.
Upon receiving the Paging message, the UE shall:
1> if in RRC_IDLE, for each of PagingNotification, if any, included in the Paging message:
   2> if the ue-Identity included in the PaingNotification matches the UE identity allocated by upper layers (i.e., 5G-S-TMSI):
      3> forward the cause “apply LP-WUS” (if support) to upper layers;
      3> (optionally) stop performing the actions related to RRC_IDLE (e.g. reception of SSB, SI, paging);
      3> monitor LP-WUS signal.
1> if in RRC_INACTIVE, for each of PagingNotification, if any, included in the Paging message:
   2> if the ue-Identity included in the PagingNotification matches the UE's stored fullI-RNTI, or
   2> if the ue-Identity included in the PagingNotification matches the UE identity allocated by upper layers:
      3> forward the cause “apply LP-WUS” (if support) to upper layers;
      3> (optionally) stop performing the actions related to RRC_INACTVE (e.g. reception of SSB, SI, paging);
      3> monitor LP-WUS signal.

### Embodiment 3

In this embodiment, a paging cause for the LP mode may be introduced into a paging message. In this way, a network may also inform a terminal device in an idle or inactive state of applying the LP mode.

In some embodiments, both a radio access network (RAN) and a core network (CN) may initiate the paging cause. In this way, a RAN or CN may use a paging method carrying the paging cause to inform a terminal device of applying the LP mode.

Continue to refer to FIG. 2, in some embodiments, the terminal device 110 may receive 215 a paging message comprising a set of identities of terminal devices and a set of paging causes corresponding to the set of identities. In other words, one identity corresponds to one paging cause. In some embodiments, an identity in the set of identities may be a RNTI, for example, an I-RNTI or any other suitable forms of RNTI. In some embodiments, an identity in the set of identities may be a TMSI. For example, a 5G-S-TMSI or any other suitable forms of TMSI. It is to be understood that the identity may adopt any other suitable forms.

For illustration, an example paging message may be configured as below.

| | |
|---|---|
| Paging ::= | SEQUENCE { [symbol] |
| pagingRecordList | PagingRecordList |
| lateNonCriticalExtension | OCTET STRING |
| nonCriticalExtension | Paging-v1700-IEs |

[symbol]

| | |
|---|---|
| [symbol] | [symbol] |
| Paging-v1700-IEs ::= | SEQUENCE { [symbol] |
| pagingRecordList-v1700 | PagingRecordList-v1700 |
| pagingGroupList-r17 | PagingGroupList-r17 |
| nonCriticalExtension | SEQUENCE { } |

[symbol]

[symbol]

| | |
|---|---|
| PagingRecordList ::= | SEQUENCE [symbol] |

[symbol]

| | |
|---|---|
| PagingRecordList-v1700 ::= | SEQUENCE [symbol] OF PagingRecord-v1700 |

[symbol]

| | |
|---|---|
| PagingGroupList-r17 ::= | SEQUENCE [symbol] OF TMGI-r17 [symbol] |

[symbol]

| | |
|---|---|
| PagingRecord ::= | SEQUENCE { [symbol] |
| ue-Identity | PagingUE-Identity, [symbol] |
| accessType | ENUMERATED { [symbol] } [symbol] |

[symbol]

[symbol]

[symbol]

| | |
|---|---|
| PagingRecord-v1700 ::= | SEQUENCE { [symbol] |
| pagingCause-r17 | ENUMERATED {voice, [symbol] } [symbol] |

[symbol]

[symbol]

| | |
|---|---|
| PagingUE-Identity ::= | CHOICE { [symbol] |
| [symbol] | [symbol] |
| [symbol] | [symbol] -Value [symbol] |

[symbol]

[symbol]

[symbol]

indicates data missing or illegible when filed

In this example, the paging message comprises a set of paging records (PagingRecordList). Each paging record comprises a UE identity (PagingUE-Identity) and a corresponding paging cause (pagingCause-r17). The paging cause may indicate the LP mode (lp-wus). It is to be understood that this paging message is merely an example, and is not intended for limitation.

In some embodiments, if an identity in the set of identities matches an identity of the terminal device 110, the terminal device 110 may determine whether a paging cause corresponding to the identity of the terminal device 110 indicates the low power mode. If the paging cause indicates the low power mode, the terminal device 110 may determine to apply the low power mode.

Upon determination of applying the LP mode, the terminal device 110 may perform 216 an operation associated with the LP mode. In some embodiments, the terminal device 110 may indicate a paging cause “apply LP mode” from a RRC layer to a NAS layer. It is to be understood that the paging cause may adopt any other forms having similar functionalities.

In some embodiments where the terminal device 110 enters the LP mode, the terminal device 110 may switch off the main radio 132. In some embodiments, the terminal device 110 may switch on the WUS receiver 131. In some embodiments, the terminal device 110 may stop performing an operation in an idle or inactive state. For example, the terminal device 110 may stop receiving at least one of a SSB, SI or a paging message. In some embodiments, the terminal device 110 may apply a configuration for the low power mode. In some embodiments, the terminal device 110 may perform a WUS monitoring. It is to be understood that the operation associated with the LP mode may comprise any combination of the above operations and any other suitable operations.

For illustration, an example procedure may be described as below.
Upon receiving the Paging message, the UE shall:
1> if in RRC_IDLE, for each of the PagingRecord, if any, included in the Paging message:
   2> if the ue-Identity included in the PagingRecord matches the UE identity allocated by upper layers:
      3> if paging cause is included and the paging cause is set to “lp-wus”:
         4> forward the ue-Identity and paging cause to the upper layers;
         4> (optionally) stop performing actions related to RRC_IDLE/INACTIVE (e.g. SSB/SI/paging);
         4> monitor LP-WUS signal.
1> if in RRC_INACTIVE, for each of the PagingRecord, if any, included in the Paging message:
   2> if the ue-Identity included in the PagingRecord matches the UE's stored fullI-RNTI, or
   2> if the ue-Identity included in the PagingRecord matches the UE identity allocated by upper layers:
      3> if paging cause is included and the paging cause is set to “lp-wus”:
         4> forward the ue-Identity and paging cause to the upper layers;
         4> (optionally) stop performing actions related to RRC_IDLE/INACTIVE (e.g. SSB/SI/paging);
         4> monitor LP-WUS signal.

### Embodiment 4

In this embodiment, a channel may be introduced to provide a configuration and notification for a terminal device to apply the LP mode. In other words, the channel is dedicated for notification of the LP mode. The channel may be called as a low power control channel (LPCCH) or any other names. In this way, a network may also inform a terminal device in an idle or inactive state of applying the LP mode.

Continue to refer to FIG. 2, in some embodiments, the terminal device 110 may obtain 217, from SI, information of the channel. For example, a system information block (SIB) may be configured to provide the information of the channel. The information of the channel may about how to acquire the channel. It is to be understood that the SIB may be any SIBs existing or to be developed. In some embodiments, the information of the channel may comprise at least one of the following: a length and offset of a repetition period for the channel; a starting slot of a transmission window for the channel; or a duration of the transmission window. For example, an example SIB (SIBX-r18) may be configured as below.

| [symbol] | |
|---|---|
| [symbol] -Config | [symbol] -Config [symbol] |
| lateNCriticalExtension | OCTET STRING |
| [symbol] | |
| [symbol] | |
| [symbol] | |
| [symbol] -Config ::= SEQUENCE { [symbol] | |
| [symbol] | [symbol] |
| [symbol] | INTEGER [symbol] |
| [symbol] | [symbol] |
| [symbol] | |
| [symbol] | |
| LPCCH-RepetitionPeriodAndOffset-17 ::= CHOICE{ | |
| [symbol] | INTEGER [symbol] |
| [symbol] | INTEGER [symbol] |
| [symbol] | INTEGER [symbol] |
| [symbol] | INTEGER [symbol] |
| [symbol] | INTEGER [symbol] |
| [symbol] | INTEGER [symbol] |
| [symbol] | INTEGER [symbol] |
| [symbol] | INTEGER [symbol] |
| [symbol] | INTEGER [symbol] |

[symbol]

[symbol]

[symbol]

indicates data missing or illegible when filed

In this example, a LPCCH configuration (lpcch-Config) is provided in the SIB. The LPCCH configuration comprises a length and offset of a repetition period for the channel (lpcch-RepetitionEeriodAndOffset), a starting slot of a transmission window (for convenience, also referred to as a LPCCH window herein) for the channel (lpcch-windowStartSlot), and a duration of the transmission window (lpcch-windowDuration). It is to be understood that this is merely an example, and does not intended for limitation.

In some embodiments, the terminal device 110 may obtain, from SIB1 (e.g., PDCCHConfig), a search space and a control resource set (CORESET) for LPCCH-PDCCH monitoring.

Based on the information of the channel and the search space and the CORESET for LPCCH-PDCCH monitoring, the terminal device 110 may determine 218 a set of occasions for monitoring the channel. The set of occasions is associated with a set of synchronization signal blocks (SSBs).

In some embodiments, the channel may be scheduled in a set of radio frames for which equation (1) is true.

$$N mod L = O \qquad ( 1 )$$

where N denotes a system frame number (SFN) of a radio frame, L denotes a length of a repetition period, and O denotes an offset of the repetition period.

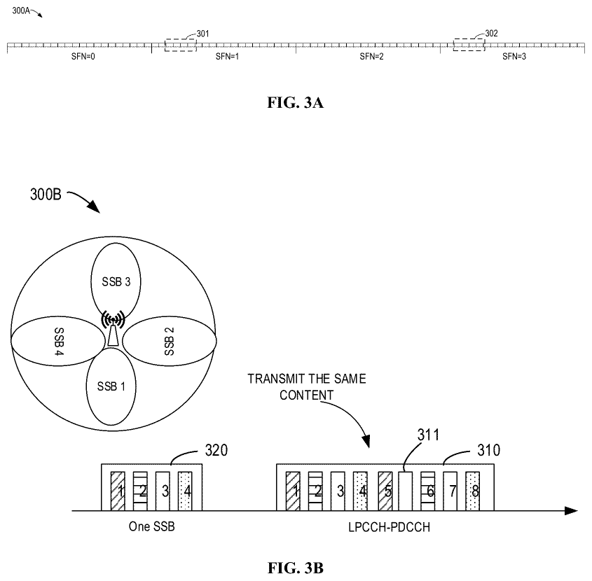

FIG. 3A illustrates a schematic diagram 300A of a time window for a LPCCH according to embodiments of the present disclosure. In this example, it is assumed that subcarrier spacing (SCS)=30 KHz, a repetition period=2 radio frames, an offset of the repetition period=1 radio frames, a starting slot=2 slots, and a duration=4 slots. Based on the equation (1), it may be derived that LPCCH windows 301, 302 . . . at SFN=1, 3, . . . will be scheduled for LPCCH. It is to be understood that this is merely an example and is not intended for limitation.

In some embodiments, the terminal device 110 may determine, as the set of occasions, a set of candidate occasions that do not overlap with an uplink symbol based on a search space for the channel and the information of the channel. The terminal device 110 may further determine a mapping between the set of occasions and the set of SSBs based on an index of an occasion, an index of a SSB, the number of occasions in a transmission window and the number of actual transmitted SSBs. For example, the [x×N+K]th PDCCH monitoring occasion for LPCCH message in LPCCH window corresponds to the Kth transmitted SSB, where x=0, 1, . . . X−1, K=1, 2, . . . N, N denotes the number of actual transmitted SSBs determined according to ssb-PositionsInBurst in SIB1 and X=CEIL (the number of PDCCH monitoring occasions in LPCCH window/N). It is to be understood that this is merely an example, and any other suitable ways are also feasible for determination of the mapping.

In some embodiments, the terminal device 110 assumes that, in the LPCCH window, PDCCH for an LPCCH message is transmitted in at least one PDCCH monitoring occasion corresponding to each transmitted SSB and thus the selection of SSB for the reception of LPCCH messages is up to UE implementation.

FIG. 3B illustrates a schematic diagram 300B of LPCCH scheduling according to embodiments of the present disclosure. As shown in FIG. 3B, there are 8 available LPCCH-PDCCH occasions within one LPCCH window 310 (depending on search space for LPCCH), and an occasion 311 is overlapped with an uplink symbol, and thus is skipped upon numbering the occasions. There are 4 SSB transmissions within one SSB burst 320 (depending on ssb-PositionsInBurst).

As mentioned above, the [x×N+K]th PDCCH monitoring occasion for LPCCH message in LPCCH window corresponds to the Kth transmitted SSB, where x=0, 1, . . . X−1,K=1, 2, . . . N, N denotes the number of actual transmitted SSBs determined according to ssb-PositionsInBurst in SIB1 and X=CEIL (the number of PDCCH monitoring occasions in LPCCH window/N). It can be derived that occasions 1 and 5 correspond to SSB 1, occasions 2 and 6 correspond to SSB 2, occasions 3 and 7 correspond to SSB 3, and occasions 4 and 8 correspond to SSB 4. The same content may be transmitted on the occasions 1 to 8. It is to be understood that this is merely an example, and is not intended for limitation.

Upon determination of the set of occasions associated with the set of SSBs, the terminal device 110 may monitor 219 the channel on the set of occasions. The network device 120 may transmit a message over the channel. In some embodiments, the message may comprise a list of identities of terminal devices. In this way, which terminal device should apply the LP mode may be informed.

In some embodiments, an identity in a list of identities may be a RNTI, for example, an I-RNTI or any other suitable forms of RNTI. In some embodiments, an identity in the list of identities may be a TMSI, for example, a 5G-S-TMSI or any other suitable forms of TMSI. It is to be understood that the identity may adopt any other suitable forms.

In some embodiments, the message may comprise a configuration for the LP mode. For example, a time domain configuration, a frequency domain configuration, a LP-WUS sequence configuration, a LP WUS group configuration or any combination of the above configurations and any other suitable configurations. It is to be noted that the message may comprise any combination of the above information and any other suitable information.

In some embodiments, the network device 120 may specify a fixed RNTI used for descrambling LPCCH-PDCCH. For example, the network device 120 may use any of the reserved RNTI values (e.g., 0xFFF3-0xFFFC) as the fixed RNTI.

For example, an example message may be configured as below.

| LPCCH-Message=r18 ::= SEQUENCE { [symbol] | |
|---|---|
| message | LPCCH-MessageType [symbol] |
| } [symbol] | |
| [symbol] | |
| LPCCH-MessageType ::= CHOICE { [symbol] | |
| c1 | CHOICE { [symbol] |
| lp-wusIndicationList | LP-WUSIndicationList |
| lp-wusConfiguration | LP-WUSConfiguration [symbol] |
| spare1 | NULL [symbol] |
| }, [symbol] | |
| messageClassExtension | SEQUENCE { } [symbol] |

} [symbol] [symbol]
indicates data missing or illegible when filed

In this example, the message comprises a list of identities of terminal devices (lp-wusIndicationList) and a configuration for the LP mode (lp-wusConfiguration). This is merely an example and is not intended for limitation.

Upon reception of the message from the channel, if an identity comprised in the message matches an identity of the terminal device 110, the terminal device 110 may determine to apply the low power mode.

Upon determination of applying the LP mode, the terminal device 110 may perform 220 an operation associated with the LP mode. In some embodiments, the terminal device 110 may indicate a cause “apply LP mode” from a RRC layer to a NAS layer. It is to be understood that the cause may adopt any other forms having similar functionalities.

In some embodiments where the terminal device 110 enters the LP mode, the terminal device 110 may switch off the main radio 132. In some embodiments, the terminal device 110 may switch on the WUS receiver 131. In some embodiments, the terminal device 110 may stop performing an operation in an idle or inactive state. For example, the terminal device 110 may stop receiving at least one of a SSB, SI or a paging message. In some embodiments, the terminal device 110 may apply a configuration for the low power mode. In some embodiments, the terminal device 110 may perform a WUS monitoring. It is to be understood that the operation associated with the LP mode may comprise any combination of the above operations and any other suitable operations.

For illustration, an example procedure may be described as below.

### Part 1 SIBx

An LP-WUS capable UE shall:
1> if the UE enters a cell broadcasting SIBx:
   2> acquire the LPCCH information (e.g. indication/LP-WUS config) based on SIBx configuration and formula as specified.

### Part 2 LPCCH-PDCCH Scheduling

The LPCCH information is transmitted periodically, using a configurable repetition period and within a configured transmission window. LPCCH transmissions are indicated via the PDCCH addressed to LPCCH-RNTI. PDCCH monitoring occasion(s) for LPCCH transmission are determined according to the common search space indicated by searchspaceLPCCH. If searchspaceLPCCH is set to zero, PDCCH monitoring occasions for LPCCH message reception in the MCCH transmission window are the same as PDCCH monitoring occasions for SIB1. If searchspaceLPCCH is not set to zero, PDCCH monitoring occasions for LPCCH message are determined based on search space indicated by searchspaceLPCCH. PDCCH monitoring occasions for LPCCH message which are not overlapping with UL symbols are sequentially numbered from one in the LPCCH transmission window. The [x×N+K]th PDCCH monitoring occasion for LPCCH message in LPCCH transmission window corresponds to the Kth transmitted SSB, where x=0, 1, . . . X−1, K=1, 2, . . . N, N is the number of actual transmitted SSBs determined according to ssb-PositionsInBurst in SIB1 and X is equal to CEIL (number of PDCCH monitoring occasions in LPCCH transmission window/N). The UE assumes that, in the LPCCH transmission window, PDCCH for an LPCCH message is transmitted in at least one PDCCH monitoring occasion corresponding to each transmitted SSB and thus the selection of SSB for the reception MCCH messages is up to UE implementation.

### Part 3 LPCCH Message

When the reception of LPCCH message, the UE shall:
1> for each of LP-WUSIndication, if the ue-Identity included in the LP-WUSIndication matches the UE identity allocated by upper layer (i.e. 5G-S-TMSI)or fullI-RNTI:
   2> apply the received LP-WUSConfiguration (e.g. time-frequency domain Config/group Config/sequence Config);
   2> (optionally) stop performing the actions related to RRC_IDLE/INACTVE (e.g. reception of SSB, SI, paging);
   2> monitor LP-WUS signal.

### Embodiment 5

In this embodiment, the terminal device 110 may make decision for applying the LP by itself based on a configuration from the network device 120. In this way, flexible control of LP-WUS monitoring may be carried out by a terminal device.

Continue to refer to FIG. 2, in some embodiments, the terminal device 110 may receive 221 a configuration for the LP mode. The configuration may comprise a set of measurement criteria. In some embodiments, the terminal device 110 may receive a RRC release message comprising the configuration for the LP mode. In some embodiments, the terminal device 110 may receive SI comprising the configuration for the LP mode. It is to be understood that the terminal device 110 may receive the configuration for the LP mode in any other suitable ways.

In some embodiments, the set of measurement criteria may comprise a measurement criterion for a terminal device with low mobility or stationary. For example, an example measurement criterion for a terminal device with low mobility may be configured as below.

Measurement criterion for UE with low mobility

[symbol]

The relaxed measurement criterion for UE with low mobility is fulfilled
when:
(Srxlev_{Ref} − Srxlev) < S [symbol] is fulfilled for a period of T [symbol] ,
Where:
Srxlev = current Srxlev value of the serving cell (dB) [symbol]
Srxlev_{Ref} = reference Srxlev value of the serving cell (dB), set as follows:
After selecting or reselecting a new cell, or
If (Srxlev − Srxlev_{Ref}) > 0, or
If the relaxed measurement criterion has not been met for T [symbol] :
The UE shall set the value of Srxlev_{Ref} to the current Srxlev value of the
serving cell. [symbol]
indicates data missing or illegible when filed

It is to be understood that any other suitable ways are also feasible.

In some embodiments, the set of measurement criteria may comprise a measurement criterion for a terminal device not at cell edge.

Measurement criterion for UE not at cell edge

The relaxed measurement criterion for UE not at cell edge is fulfilled
when:
Srxlev > S_{SearchThresholdP}, and,
Squal > S_{SearchThresholdQ}, if S_{SearchThresholdQ} is configured [symbol]
Where:
Srxlev = current Srxlev value of the serving cell (dB).
Squal = current Squal value of the serving cell (dB). [symbol]
indicates data missing or illegible when filed

It is to be understood that any other suitable ways are also feasible. The set of measurement criteria may comprise any other suitable criteria, and is not limited to the above examples.

In some embodiments, the configuration for the LP mode may further comprise a time domain configuration indicating where the terminal device 110 should monitor a LP WUS from a time domain view. In some embodiments, the configuration for the LP mode may comprise a frequency domain configuration indicating where the terminal device 110 should monitor a LP WUS from a frequency domain view. In some embodiments, the configuration for the LP mode may comprise a LP WUS sequence configuration indicating a LP WUS pattern. In some embodiments, the configuration for the LP mode may comprise a LP WUS group configuration indicating which LP WUS UE group the terminal device 110 should monitor. It is to be understood that the configuration for the LP mode may comprise any combination of the above configurations and any other suitable configurations.

The terminal device 110 may perform 222 signal measurements based on the set of measurement criteria. If the set of measurement criteria is fulfilled, the terminal device 110 may determine to apply the low power mode.

Upon determination of applying the LP mode, the terminal device 110 may perform 223 an operation associated with the LP mode. In some embodiments, the terminal device 110 may indicate a cause “apply LP mode” from a medium access control (MAC) layer to a RRC layer. It is to be understood that the cause may adopt any other forms having similar functionalities.

In some embodiments where the terminal device 110 enters the LP mode, the terminal device 110 may switch off the main radio 132. In some embodiments, the terminal device 110 may switch on the WUS receiver 131. In some embodiments, the terminal device 110 may stop performing an operation in an idle or inactive state. For example, the terminal device 110 may stop receiving at least one of a SSB, SI or a paging message. In some embodiments, the terminal device 110 may apply a configuration for the low power mode. In some embodiments, the terminal device 110 may perform a WUS monitoring. It is to be understood that the operation associated with the LP mode may comprise any combination of the above operations and any other suitable operations.

For illustration, an example procedure may be described as below.

### Part 1 RRCRelease

upon reception of RRCRelease, the LP-WUS capable UE shall:
1> if the RRCRelease includes LP-WUS related configuration:
   2> if the LP-WUS measurement criteria is included:
      3> store the LP-WUS related configuration; (means UE will temporarily perform actions related to RRC_IDLE/INACTVE)
      3> performing the measurements based on LP-WUS measurement criteria.

### Part 1a SI

The LP-WUS capable UE shall:
1> if the UE enters a cell broadcasting SIBx containing LP-WUS related configuration and LP-WUS measurement criterion:
   2> performing the measurements based on LP-WUS measurement criteria.
      Part 2 IDLE/INACTIVE procedure

If the UE supports LP-WUS capabilities and LP-WUS measurement criteria is provided by RRCRelease/SI, the UE shall evaluate the LP-WUS measurement criteria.
1> if the LP-WUS measurement criteria is fulfilled (could be mobility and/or not-at-cell-edge):
   2> stop performing the actions related to RRC_IDLE/INACTIVE;
   2> monitor LP-WUS signal based on the configuration.

So far, a solution of a network notifying a terminal device to apply a LP mode is described. In this way, a notification of a transition of a LP mode may be supported.

### Example Implementation of Request for LP Mode

In some embodiments, the terminal device 110 determines whether to apply a LP mode during which a WUS monitoring is performed. The determination may be performed by any suitable ways, and the present disclosure does not make limitation for this.

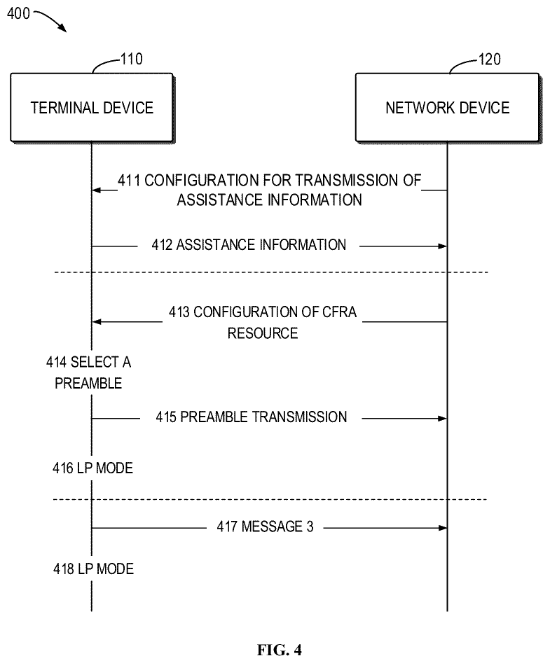

If the terminal device 110 determines to apply the LP mode, the terminal device 110 transmits a request for applying the LP mode. For illustration, some example embodiments will be described below in connection with Embodiments 6 to 8 and FIG. 4. FIG. 4 illustrates a schematic diagram illustrating a process 400 of communication according to embodiments of the present disclosure. For the purpose of discussion, the process 400 will be described with reference to FIG. 1A. The process 400 may involve the terminal device 110 and the network device 120 as illustrated in FIG. 1A. It is to be understood that the steps and the order of the steps in FIG. 4 are merely for illustration, and not for limitation. For example, the order of the steps may be changed. Some of the steps may be omitted or any other suitable additional steps may be added.

### Embodiment 6

In this embodiment, the terminal device 110 may transmit the request by assistance information. In this way, a terminal device in a connected state may apply the LP mode by transmitting a request.

With reference to FIG. 4, in some embodiments, the network device 120 may transmit 411 a configuration for transmission of the assistance information. In some embodiments, the configuration for transmission of the assistance information may comprise a timer (for convenience, also referred to as a further timer or a prohibit timer herein). For example, an IE OtherConfig may comprise the configuration for transmission of the assistance information (lp-wusAssistanceConfig) as below.

| | |
|---|---|
| OtherConfig-v1800 ::= | SEQUENCE { [symbol] |
| lp-wusAssistanceConfig | SetupRelease {LP-WUSAssistanceConfig} |

...

[symbol]

[symbol]

[symbol]

| | |
|---|---|
| LP-WUSAssistanceConfig ::= | SEQUENCE { [symbol] |
| lp-wusProhibitTimer | ENUMERATED {s0, s0dot5, s1, s2, s5, s10, s20, s30, |
| | s60, s90, s120, s300, s600, spare1} |

[symbol]

[symbol]

indicates data missing or illegible when filed

In this example, the IE OtherConfig may indicate a prohibit timer (lp-wusProhibitTimer).

When the terminal device 110 determines to apply the LP mode, the terminal device 110 may transmit 412 assistance information based on the configuration for transmission of assistance information. In some embodiments, the terminal device 110 may transmit the assistance information via an UE assistance information (UAI) message. It is to be understood that any other suitable messages are also feasible.

In some embodiments, the assistance information may comprise a preference on applying the LP mode. In some embodiments, the assistance information may comprise a preference on a timer for the LP mode. It is to be understood that the assistance information may comprise any combination of the above information and any other suitable information.

In some embodiments where the terminal device 110 is capable of providing assistance information for the LP mode in a connected state, the terminal device 110 may initiate an UAI procedure if the terminal device 110 provides a preference on applying the LP mode or the timer for the LP mode, or upon change of the above information.

For example, an example UAI message may be configured as below.

UEAssistanceInformation-v1800-IEs ::= SEQUENCE

[symbol]

| | |
|---|---|
| lp-wusAssistance | LP-WUSAssistance [symbol] |
| nonCriticalExtension | UEAssistanceInformation-v18xx-IEn [symbol] |

[symbol]

[symbol]

| | |
|---|---|
| LP-WUSAssistance ::= | SEQUENCE { [symbol] |
| applyLP-WUSMode | BOOLEAN [symbol] |
| preferredLP-WUSTimer | ENUMERATED [symbol] min5, min10, min15, min30,... [symbol] |

[symbol]

[symbol]

indicates data missing or illegible when filed

In this example, the UAI message may comprise an IE LP-WUSAssistance, and the IE LP-WUSAssistance may comprise a preference on applying the LP mode (applyLP-WUSMode) and a preference on a timer for the LP mode (preferredLP-WUSTimer). It is to be understood that this is merely an example and is not intended for limitation.

In some embodiments where the configuration for transmission of the assistance information comprises the further timer (i.e., a prohibit timer), if no assistance information is transmitted since reception of the configuration or if the assistance information is different from a previous assistance information indicated in a previous transmission of assistance information and the further timer is not running, the terminal device 110 may start the further timer and initiate the transmission of the assistance information. In some embodiments, if the further timer is running, the terminal device 110 may not transmit further assistance information. In this way, frequent transmissions of assistance information are avoided.

For illustration, an example procedure may be described as below.

### Part 1 Initiation of UAI

1> if configured to provide LP-WUS assistance information:
   2> if the UE did not transmit a UEAssistanceInformation message with LP-WUSAssistance since it was configured to provide applyLP-WUSMode or preferredLP-WUSTimer, or
   2> if the current LP-WUSAssistance information is different from the one indicated in the last transmission of the UEAssistanceInformation message including LP-WUSAssistance and the LP-WUSProhibitTimer is not running:
      3> start the LP-WUSProhibitTimer with the timer value set to lp-wusProhibitTimer;
      3> initiate transmission of the UEAssistanceInformation message in accordance with LP-WUS assistance.

### Part 2 Transmission of UAI

1> if the transmission of the UEAssistanceInformation message is initiated to provide LP-WUS assistance information:
   2> include applyLP-WUSMode (if present) in the LP-WUSAssistance IE;
   2> include preferredLP-WUSTimer (if present) in the LP-WUSAssistance IE;
1> Submit the UEAssistanceInformation message to lower layer for transmission.

### Embodiment 7

In this embodiment, the terminal device 110 may transmit the request by a random access (RA) procedure for the LP mode. In this way, a terminal device in an idle or inactive state may be provided with a chance to request applying the LP mode.

Continue to refer to FIG. 4, in some embodiments, the terminal device 110 may obtain 413, from SI, a configuration for a contention-free random access (CFRA) resource for the request. In other words, a type of CFRA resource may be introduced in SIB for a terminal device in an idle or inactive state to request applying the LP mode by performing CFRA.

In some embodiments, the configuration may comprise a preamble index (denoted as ra-PreambleStartIndex) used for the RA procedure. For example, a dedicated preamble index may be selected to perform CFRA preamble transmission for the request.

For illustration, an example configuration for CFRA resource may be configured as below.

| | |
|---|---|
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |
| [symbol] | [symbol] |

[symbol]

indicates data missing or illegible when filed

In some embodiments, the configuration for CFRA resource may further comprise information of occasions for the RA procedure. In some embodiments, the information of occasions for the RA procedure may comprise at least one of the following: a mapping between SSBs and ROs (e.g., ssb-perRACH-Occasion), the number of association periods between SSBs and PRACH resources (e.g., lp-wusRequestPeriod), the index of which association period should be used (e.g., ra-AssociationPeriodIndex), and which RO should be used when one SSB index corresponds to multiple ROs (e.g., ra-ssb-OcaasionMaskIndex). It is to be understood that any other suitable information may also be feasible.

The terminal device 110 may select 414, from a set of RA preambles determined based on the preamble index, a RA preamble corresponding to a selected SSB. In some embodiments, if N SSB indexes are associated with a RA occasion (RO), where N>=1, for the i-th SSB (i=0, . . . , N−1), the preamble with preamble index=ra-PreambleStartIndex+i is used for the request; For N<1, the preamble with preamble index=ra-PreambleStartIndex is used for the request.

Then the terminal device 110 may perform 415 a preamble transmission based on the RA preamble and the information of occasions. In some embodiments, if a random access response (RAR) is received and the RAR comprises a MAC sub-protocol data unit (subPDU) with a RA preamble identifier corresponding to the RA preamble, the terminal device 110 may determine that reception of the RAR is successful.

If the RAR comprises a MAC subPDU with only a random access preamble identifier (RAPID), the terminal device 110 may perform 416 an operation associated with the LP mode. In some embodiments where the terminal device 110 enters the LP mode, the terminal device 110 may switch off the main radio 132 of the terminal device 110. In some embodiments, the terminal device 110 may switch on the WUS receiver 131 of the terminal device 110. In some embodiments, the terminal device 110 may indicate, from a lower layer to upper layers of the terminal device 110, reception of an acknowledgement for the request. In some embodiments, the terminal device 110 may stop performing an operation in an idle or inactive state. In some embodiments, the terminal device 110 may perform a WUS monitoring. It is to be understood that any other suitable operations associated with the LP mode may also be feasible.

For illustration, an example CFRA procedure may be described as below.

The MAC entity shall:
1> if the Random Access procedure was initiated for LP-WUS request; and
1> if the Random Access Resources for LP-WUS request have been explicitly provided by network (i.e. LP-WUSRequestConfig):
   2> if at least one of the SSBs with SS-RSRP above rsrp-ThresholdSSB is available:
      3> select an SSB with SS-RSRP above rsrp-ThresholdSSB.
   2> else:
      3> select any SSB.
   2> select a Random Access Preamble corresponding to the selected SSB, from the Random Access Preamble(s) determined according to ra-PreambleStartIndex;
   2> set the PREAMBLE_INDEX to selected Random Access Preamble.
1> perform the Random Access Preamble transmission procedure.

Once the Random Access Preamble is transmitted and regardless of the possible occurrence of a measurement gap, the MAC entity shall:
1> if a downlink assignment has been received on the PDCCH for the RA-RNTI and the received TB is successfully decoded:
   2> if the Random Access Response contains a MAC subPDU with Random Access Preamble identifier corresponding to the transmitted PREAMBLE_INDEX:
      3> consider this Random Access Response reception successful.
   2> if the Random Access Response reception is considered successful:
      3> if the Random Access Response includes a MAC subPDU with RAPID only:
         4> consider this Random Access procedure successfully completed;
         4> indicate the reception of an acknowledgement for LP-WUS request to upper layers (i.e. UE RRC);

### (RRC Part)

4> (optionally) stop performing the actions related to RRC_IDLE/INACTVE.
4> monitor LP-WUS signal.

### Embodiment 8

In this embodiment, in uplink common control channel 1 (UL-CCCH 1), a type of RRC message may be introduced for a terminal device in an idle or inactive state to request applying the LP mode by performing contention-based random access (CBRA) within message 3 (Msg3). In this way, a terminal device in an idle or inactive state may also be provided with a chance to request applying the LP mode.

Continue to refer to FIG. 4, in some embodiments, if a contention-based preamble is selected to perform a RA procedure, the terminal device 110 may transmit 417 a message 3 by causing a message dedicated for the LP mode to be comprised in a service data unit (SDU) for an UL-CCCH (e.g., UL-CCCH 1). In some embodiments, the message dedicated for the LP mode may comprise at least an identity of the terminal device 110.

In some embodiments, the identity may be a RNTI, for example, an I-RNTI or any other suitable forms of RNTI. In some embodiments, the identity may be a TMSI, for example, a 5G-S-TMSI or any other suitable forms of TMSI. It is to be understood that the identity may adopt any other suitable forms.

For illustration, an example UL-CCCH 1 may be configured as below.

| UL-CCCH1-Message ::= | SEQUENCE [symbol] |
|---|---|
| message | UL-CCCH1-MessageType [symbol] |
| } [symbol] | |
| [symbol] | |
| UL-CCCH1-MessageType ::= | CHOICE { [symbol] |
| c1 | CHOICE { [symbol] |
| rrcResumeRequest1 | RRCResumeRequest1, |
| rrcLP-WUSRequest | RRCLP-WUSRequest, [symbol] |

```
    spare2 NULL, [symbol]
    spare1 NULL

[symbol]

[symbol]

  }, [symbol]
  messageClassExtension SEQUENCE { } [symbol]
} [symbol] [symbol]
indicates data missing or illegible when filed
```

In this example, the UL-CCCH 1 may be configured with a message dedicated for the LP mode (rrcLP-WUSRequest). It is to be understood that this is merely an example, and is not intended for limitation.

In some embodiments, if a contention resolution identity in a medium access control control element (MAC CE) of a MAC PDU matches the SDU, the terminal device 110 may determine that contention resolution is successful. In some embodiments, the MAC PDU may comprise a configuration for the LP mode.

Upon determination that the contention resolution is successful, the terminal device 110 may perform 418 an operation associated with the LP mode. In some embodiments where the terminal device 110 enters the LP mode, the terminal device 110 may switch off the main radio 132 of the terminal device 110. In some embodiments, the terminal device 110 may switch on the WUS receiver 131 of the terminal device 110. In some embodiments, the terminal device 110 may indicate, from a lower layer to upper layers of the terminal device 110, reception of an acknowledgement for the request. In some embodiments, the terminal device 110 may stop performing an operation in an idle or inactive state. In some embodiments, the terminal device 110 may perform a WUS monitoring. It is to be understood that any other suitable operations associated with the LP mode may also be feasible.

For illustration, an example CBRA procedure may be described as comprising at least the following contents.
Step 1. (if no LP-WUSRequestConfig) UE selects the contention-based preamble to perform the Random Access Preamble transmission procedure.
Step 2. UE receives a downlink assignment (Msg2/RAR MAC PDU) on the PDCCH for the RA-RNTI.
Step 3. (if no RAPID-only) process Time Advance Command, Power Ramping, UL Grant, TC-RNTI.

After performing the above procedure, UE sends Msg3 by containing UL-CCCH1 SDU with rrcLP-WUSRequest message.

Once Msg3 is transmitted the MAC entity shall:
1> if notification of a reception of a PDCCH transmission of the SpCell is received from lower layers:
   2> if the MAC PDU is successfully decoded:
      3> stop ra-ContentionResolutionTimer;
      3> if the MAC PDU contains a UE Contention Resolution Identity MAC CE; and
      3> if the UE Contention Resolution Identity in the MAC CE matches the CCCH SDU transmitted in Msg3:
         4> consider this Contention Resolution successful and finish the disassembly and demultiplexing of the MAC PDU;
         4> if this Random Access procedure was initiated for LP-WUS request:
         5> indicate the reception of an acknowledgement for LP-WUS request to upper layers (i.e. UE RRC);
(RRC)
   5> (optionally) stop performing the actions related to RRC_IDLE/INACTVE.
   5> monitor LP-WUS signal.

So far, a solution of a terminal device requesting a network for a LP mode is described. In this way, a notification of a transition of a LP mode may also be supported.

### Example Implementation of Exit of LP Mode

When a terminal device is monitoring a LP WUS signal, if the terminal device receives the LP WUS signal, the terminal device will exit the LP mode. A procedure after exit of the LP mode needs to be specified. Some example embodiments will be described in connection with Embodiments 9 to 10.

### Embodiment 9

In this embodiment, after exit of the LP mode, the terminal device 110 may perform an operation in an idle or inactive state. In this way, a procedure after exit of the LP mode may be specified.

In some embodiments, the terminal device 110 may stop the WUS monitoring. In some embodiments, the terminal device 110 may perform a cell selection procedure. In some embodiments, if the terminal device 110 camps on a cell, the terminal device 110 may monitor at least one of a paging channel, a short message or SI from the cell.

In some embodiments, if a short message is received, the terminal device 110 may perform an operation associated with the short message, stop the operation in the idle or inactive state, and perform the WUS monitoring. In some embodiments, if no identity comprised in the paging message matches an identity of the terminal device 110, the terminal device 110 may stop the operation in an idle or inactive state, and perform the WUS monitoring.

In some embodiments, this embodiment may respond to those terminal devices who apply the LP mode from an idle or inactive state. It is to be understood that this embodiment may also be applied to any other scenarios.

For example, an example procedure may be described as below.
Upon reception of LP-WUS signal, the UE shall:
1> stop LP-WUS monitoring;
1> perform cell selection as specified in TS 38.304 (once a suitable cell is found, the cell shall be selected).

When camped on a cell normally, the UE shall perform the following tasks:
monitor the paging channel of the cell according to information broadcast in SIB1;
monitor Short Messages transmitted with P-RNTI over DCI;
monitor relevant System Information;
perform necessary measurements for the cell reselection evaluation procedure;
execute the cell reselection evaluation process on the following occasions/triggers:

Upon reception of paging, the UE shall:
1> if the UE receives a short message, the UE shall:
   2> process the actions related to short message information (e.g. SI/PTW . . . );
   2> stop the actions related to RRC_IDLE/INACTIVE;
   2> monitor LP-WUS signal again.
1> if the UE receives a paging message, the UE shall:
   2> if the UE identity included in paging message does not match the UE identity allocated by upper layer or I-RNTI:
      3> stop the actions related to RRC_IDLE/INACTIVE;
      3> monitor LP-WUS signal again.
   2> else:
      3> perform the actions related to paging procedure.

### Embodiment 10

In this embodiment, after exit of the LP mode, the terminal device 110 may perform an operation in a connected state. In this way, a procedure after exit of the LP mode may also be specified.

In some embodiments, the terminal device 110 may stop the WUS monitoring. In some embodiments, the terminal device 110 may perform a cell selection procedure. In some embodiments, if the terminal device 110 camps on a cell, the terminal device 110 may monitor SI from the cell. In some embodiments, the terminal device 110 may initiate a RA procedure.

In some embodiments, this embodiment may respond to those terminal devices who apply the LP mode from a connected state. It is to be understood that this embodiment may also be applied to any other scenarios.

For example, an example procedure may be described as below.
Upon reception of LP-WUS signal, the UE shall:
1> stop LP-WUS monitoring;
1> perform cell selection as specified in TS 38.304 (once a suitable cell is found, the cell shall be selected).

When camped on a cell normally, the UE shall perform the following tasks:
monitor relevant System Information (for acquiring RA resource and synchronization);
1> initiate random access procedure immediately after acquiring RA resource and synchronization.

So far, a procedure after exit of a LP mode is described. In this way, UE behavior after exit of a LP mode may be specified.

It is to be understood that the solutions as described in Embodiments 1 to 10 may be used separately or in any suitable combination.

### Example Implementation of Methods

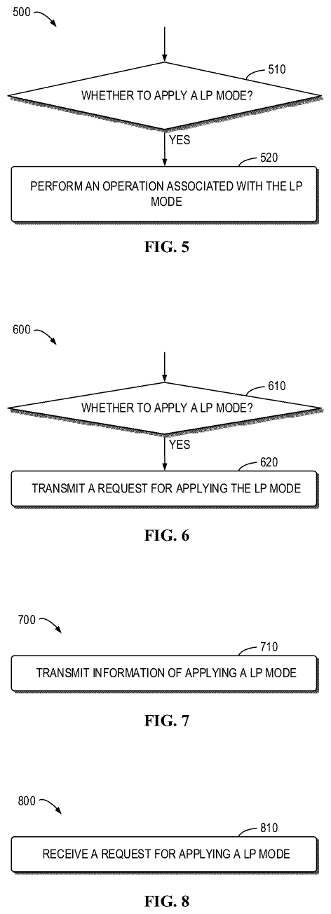

Corresponding to the above processes, embodiments of the present disclosure provide methods of communication implemented at a terminal device and a network device. These methods will be described below with reference to FIGS. 5 to 8.

FIG. 5 illustrates an example method 500 of communication implemented at a terminal device in accordance with some embodiments of the present disclosure. For example, the method 500 may be performed at the terminal device 110 as shown in FIG. 1A. For the purpose of discussion, in the following, the method 500 will be described with reference to FIG. 1A. It is to be understood that the method 500 may include additional blocks not shown and/or may omit some blocks as shown, and the scope of the present disclosure is not limited in this regard.

At block 510, the terminal device 110 determines whether to apply a LP mode during which a WUS monitoring is performed.

In some embodiments, if a RRC release message comprising first information of the LP mode is received, the terminal device 110 may determine to apply the LP mode. In some embodiments, the first information of the LP mode may comprise at least one of the following: an indication of the LP mode, a configuration for the LP mode, or a timer for the LP mode.

In some embodiments, if the RRC release message is received, the terminal device 110 may start a timer. If the timer expires, the terminal device 110 may determine to apply the LP mode.

In some embodiments, if a condition for cell re-selection is fulfilled while the timer is running and the terminal device 110 supports mobility in the LP mode, the terminal device 110 may restart the timer. In some embodiments, if the terminal device 110 performs a SDT procedure and the timer is running, the terminal device 110 restarts the timer. In some embodiments, if the terminal device 110 receives a MBS and the timer is running, the terminal device 110 may restart the timer. In some embodiments, if a condition for cell re-selection is fulfilled while the timer is running and the terminal device 110 does not support mobility in the LP mode, the terminal device 110 may stop the timer. In some embodiments, if the terminal device 110 enters a connected state and the timer is running, the terminal device 110 may stop the timer.

In some embodiments, the terminal device 110 may receive a paging message comprising second information of the LP mode, the second information indicating a set of identities of terminal devices. If an identity in the set matches an identity of the terminal device, the terminal device 110 may determine to apply the LP mode. In some embodiments, the terminal device 110 may further receive DCI scheduling reception of the paging message and only comprising an indication of the LP mode.

In some embodiments, the terminal device 110 may receive a paging message comprising a set of identities of terminal devices and a set of paging causes corresponding to the set of identities. If an identity in the set of identities matches an identity of the terminal device 110, the terminal device 110 may determine whether a paging cause corresponding to the identity of the terminal device indicates the LP mode. If the paging cause indicates the LP mode, the terminal device 110 may determine to apply the LP mode.

In some embodiments, the terminal device 110 may obtain, from system information, information of a channel dedicated for notification of the LP mode; determine a set of occasions for monitoring the channel, the set of occasions being associated with a set of synchronization signal blocks; and if a message from the channel is received based on the set of occasions and the set of synchronization signal blocks and an identity comprised in the message matches an identity of the terminal device 110, the terminal device 110 may determine to apply the LP mode.

In some embodiments, the information of the channel comprises at least one of the following: a length and offset of a repetition period for the channel; a starting slot of a transmission window for the channel; or a duration of the transmission window.

In some embodiments, the terminal device 110 may determine, as the set of occasions, a set of candidate occasions that do not overlap with an uplink symbol based on a search space for the channel and the information of the channel; and determines a mapping between the set of occasions and the set of synchronization signal blocks based on an index of an occasion, an index of a SSB, the number of occasions in a transmission window and the number of actual transmitted SSBs. In some embodiments, the message may comprise at least one of the following: a list of identities of terminal devices, or a configuration for the LP mode.

In some embodiments, the terminal device 110 may receive a configuration for the LP mode, the configuration comprising a set of measurement criteria; and perform signal measurements based on the set of measurement criteria. If the set of measurement criteria is fulfilled, the terminal device 110 may determine to apply the LP mode.

In some embodiments, the terminal device 110 may receive a RRC release message comprising the configuration for the LP mode. In some embodiments, the terminal device 110 may receive system information comprising the configuration for the LP mode.

In some embodiments, the set of measurement criteria may comprise at least one of the following: a measurement criterion for a terminal device with low mobility, a measurement criterion for a terminal device with stationary, or a measurement criterion for a terminal device not at cell edge.

If the terminal device 110 determines to apply the LP mode, the method 500 proceeds to block 520. At block 520, based on a determination of applying the LP mode, the terminal device 110 performs an operation associated with the LP mode.

In some embodiments, the terminal device 110 may perform the operation associated with the LP mode by at least one of the following: switching off the main radio 132 of the terminal device 110; switching on the WUS receiver 131 of the terminal device 110; indicating, from a lower layer to upper layers of the terminal device 110, a cause of applying the LP mode; stopping performing an operation in an idle or inactive state; applying a configuration for the LP mode; or performing a WUS monitoring.

In some embodiments, if a WUS is received, the terminal device 110 may perform an operation in an idle or inactive state. In some embodiments, the terminal device 110 may perform the operation in the idle or inactive state by at least one of the following: stopping the wake-up signal monitoring; performing a cell selection procedure; or if the terminal device camps on a cell, monitoring at least one of a paging channel, a short message or system information from the cell.

In some embodiments, if a short message is received, the terminal device 110 may perform an operation associated with the short message; stop the operation in the idle or inactive state; and perform the WUS monitoring. In some embodiments, if no identity comprised in the paging message matches an identity of the terminal device 110, the terminal device 110 may stop the operation in an idle or inactive state, and perform the WUS monitoring.

In some embodiments, if a WUS is received, the terminal device 110 may perform an operation in a connected state. In some embodiments, the terminal device 110 may perform the operation in the connected state by at least one of the following: stopping the WUS monitoring; performing a cell selection procedure; if the terminal device 110 camps on a cell, monitoring system information from the cell; or initiating a RA procedure.

With the method 500, a network may notify a terminal device to apply a LP mode.

FIG. 6 illustrates another example method 600 of communication implemented at a terminal device in accordance with some embodiments of the present disclosure. For example, the method 600 may be performed at the terminal device 110 as shown in FIG. 1A. For the purpose of discussion, in the following, the method 600 will be described with reference to FIG. 1A. It is to be understood that the method 600 may include additional blocks not shown and/or may omit some blocks as shown, and the scope of the present disclosure is not limited in this regard.

At block 610, the terminal device 110 determines whether to apply a LP mode during which a WUS monitoring is performed. If the terminal device 110 determines to apply the LP mode, the method 600 proceeds to block 620.

At block 620, based on a determination of applying the LP mode, the terminal device 110 transmits a request for applying the LP mode. In some embodiments, the terminal device 110 may transmit the request by assistance information. In some embodiments, the terminal device 110 may transmit the request by a RA procedure for the LP mode.

In some embodiments, the terminal device 110 may receive a configuration for transmission of the assistance information; and transmit assistance information comprising at least one of the following: a preference on applying the LP mode, or a preference on a timer for the LP mode.

In some embodiments where the configuration for transmission of the assistance information comprises a further timer, if no assistance information is transmitted since reception of the configuration or if the assistance information is different from a previous assistance information indicated in a previous transmission of assistance information and the further timer is not running, the terminal device 110 may start the further timer, and initiate the transmission of the assistance information. In some embodiments, if the further timer is running, the terminal device 110 may transmit no further assistance information.

In some embodiments, the terminal device 110 may obtain, from SI, a configuration for a CFRA resource for the request, the configuration comprising at least one of a preamble index used for the RA procedure or information of occasions for the RA procedure. The terminal device 110 may select, from a set of RA preambles determined based on the preamble index, a RA preamble corresponding to a selected SSB. In some embodiments, the terminal device 110 may perform a preamble transmission based on the RA preamble and the information of occasions.

In some embodiments, if a RAR is received and the RAR comprises a MAC sub-PDU with a RA preamble identifier corresponding to the RA preamble, the terminal device 110 may determine that reception of the RA response is successful. If the RAR comprises a MAC sub-PDU with only a RA preamble identifier, the terminal device 110 may perform an operation associated with the LP mode.

In some embodiments, if a contention-based preamble is selected to perform the RA procedure, the terminal device 110 may transmit a message 3 by causing a message dedicated for the LP mode to be comprised in a SDU for an UL-CCCH.

In some embodiments, if a contention resolution identity in a MAC CE of a MAC PDU matches the SDU, the terminal device 110 may determine that contention resolution is successful, and perform an operation associated with the LP mode. In some embodiments, the MAC PDU comprises a configuration for the LP mode.

In some embodiments, the terminal device 110 may perform the operation associated with the LP mode comprises at least one of the following: switching off the main radio 132 of the terminal device 110; switching on the WUS receiver 131 of the terminal device 110; indicating, from a lower layer to upper layers of the terminal device 110, reception of an acknowledgement for the request; stopping performing an operation in an idle or inactive state; or performing a WUS monitoring.

In some embodiments, if a WUS is received, the terminal device 110 may perform an operation in an idle or inactive state. In some embodiments, the terminal device 110 may perform the operation in the idle or inactive state by at least one of the following: stopping the wake-up signal monitoring; performing a cell selection procedure; or if the terminal device camps on a cell, monitoring at least one of a paging channel, a short message or system information from the cell.

In some embodiments, if a short message is received, the terminal device 110 may perform an operation associated with the short message; stop the operation in the idle or inactive state; and perform the WUS monitoring. In some embodiments, if no identity comprised in the paging message matches an identity of the terminal device 110, the terminal device 110 may stop the operation in an idle or inactive state, and perform the WUS monitoring.

In some embodiments, if a WUS is received, the terminal device 110 may perform an operation in a connected state. In some embodiments, the terminal device 110 may perform the operation in the connected state by at least one of the following: stopping the WUS monitoring; performing a cell selection procedure; if the terminal device 110 camps on a cell, monitoring system information from the cell; or initiating a RA procedure.

With the method 600, a terminal device may request a network for applying a LP mode.

FIG. 7 illustrates an example method 700 of communication implemented at a network device in accordance with some embodiments of the present disclosure. For example, the method 700 may be performed at the network device 120 as shown in FIG. 1A. For the purpose of discussion, in the following, the method 700 will be described with reference to FIG. 1A. It is to be understood that the method 700 may include additional blocks not shown and/or may omit some blocks as shown, and the scope of the present disclosure is not limited in this regard.

At block 710, the network device 120 transmits information of applying a LP mode during which a WUS monitoring is performed.

In some embodiments, the network device 120 may transmit the information of applying the LP mode by transmitting a RRC release message comprising first information of the LP mode.

In some embodiments, the first information of the LP mode comprises at least one of the following: an indication of the LP mode, a configuration for the LP mode, or a timer for the LP mode.

In some embodiments, the network device 120 may transmit the information of applying the LP mode by transmitting a paging message comprising second information of the low power mode, the second information indicating a set of identities of terminal devices. In some embodiments, the network device 120 may further transmit DCI scheduling reception of the paging message and only comprising an indication of the LP mode.

In some embodiments, the network device 120 may transmit the information of applying the LP mode by transmitting a paging message comprising a set of identities of terminal devices and a set of paging causes corresponding to the set of identities, at least one paging cause in the set of paging causes indicating the LP mode.

In some embodiments, the network device 120 may transmit the information of applying the LP mode by transmitting, in SI, information of a channel dedicated for notification of the LP mode; determining a set of occasions associated with the channel, the set of occasions being associated with a set of SSBs; and transmitting a message based on the set of occasions and the set of SSBs.

In some embodiments, the information of the channel may comprise at least one of the following: a length and offset of a repetition period for the channel; a starting slot of a transmission window for the channel; or a duration of the transmission window.

In some embodiments, the network device 120 may determine the set of occasions by: determining, as the set of occasions, a set of candidate occasions that do not overlap with an uplink symbol based on a search space for the channel and the information of the channel; and determining a mapping between the set of occasions and the set of SSBs based on an index of an occasion, an index of a SSB, the number of occasions in a transmission window and the number of actual transmitted SSBs.

In some embodiments, the message may comprise at least one of the following: a list of identities of terminal devices, or a configuration for the LP mode.

In some embodiments, the network device 120 may transmit the information of applying the LP mode by: transmitting a configuration for the LP mode, the configuration comprising a set of measurement criteria.

In some embodiments, the network device 120 may transmit the configuration for the LP mode by: transmitting a RRC release message comprising the configuration for the LP mode; or transmitting SI comprising the configuration for the LP mode.

In some embodiments, the set of measurement criteria may comprise at least one of the following: a measurement criterion for a terminal device with low mobility, a measurement criterion for a terminal device with stationary, or a measurement criterion for a terminal device not at cell edge.

With the method 700, a network may notify a terminal device to apply a LP mode.

FIG. 8 illustrates another example method 800 of communication implemented at a network device in accordance with some embodiments of the present disclosure. For example, the method 800 may be performed at the network device 120 as shown in FIG. 1A. For the purpose of discussion, in the following, the method 800 will be described with reference to FIG. 1A. It is to be understood that the method 800 may include additional blocks not shown and/or may omit some blocks as shown, and the scope of the present disclosure is not limited in this regard.

At block 810, the network device 120 receives a request for applying a LP mode during which main radio of a terminal device is turned off and a wake-up signal receiver of the terminal device is turned on.

In some embodiments, the network device 120 may receive the request by: receiving the request by assistance information; or receiving the request by a RA procedure for the low power mode.

In some embodiments, the network device 120 may transmit a configuration for transmission of the assistance information; and receive assistance information comprising at least one of the following: a preference on applying the LP mode, or a preference on a timer for the LP mode. In some embodiments, the configuration for transmission of the assistance information may comprise a further timer.

In some embodiments, the network device 120 may transmit, in SI, a configuration for a CFRA resource dedicated for the request, the configuration comprising at least one of a preamble index used for the RA procedure or information of occasions for the RA procedure.

In some embodiments, the network device 120 may further receive a message 3 that comprises a message dedicated for the LP mode in a SDU for an UL-CCCH.

With the method 800, a terminal device may request a network for applying a LP mode.

### Example Implementation of Device and Apparatus

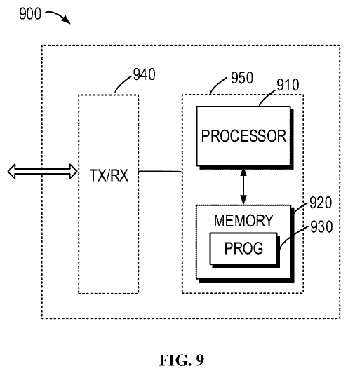

FIG. 9 is a simplified block diagram of a device 900 that is suitable for implementing embodiments of the present disclosure. The device 900 can be considered as a further example implementation of the terminal device 110 or the network device 120 as shown in FIG. 1A. Accordingly, the device 900 can be implemented at or as at least a part of the terminal device 110 or the network device 120.

As shown, the device 900 includes a processor 910, a memory 920 coupled to the processor 910, a suitable transmitter (TX) and receiver (RX) 940 coupled to the processor 910, and a communication interface coupled to the TX/RX 940. The memory 910 stores at least a part of a program 930. The TX/RX 940 is for bidirectional communications. The TX/RX 940 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 930 is assumed to include program instructions that, when executed by the associated processor 910, enable the device 900 to operate in accordance with the embodiments of the present disclosure, as discussed herein with reference to FIGS. 1A to 8. The embodiments herein may be implemented by computer software executable by the processor 910 of the device 900, or by hardware, or by a combination of software and hardware. The processor 910 may be configured to implement various embodiments of the present disclosure. Furthermore, a combination of the processor 910 and memory 920 may form processing means 950 adapted to implement various embodiments of the present disclosure.

The memory 920 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 920 is shown in the device 900, there may be several physically distinct memory modules in the device 900. The processor 910 may be of any type suitable to the local technical network, and may include one or more of general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

In some embodiments, a terminal device comprises a circuitry configured to: determine, at a terminal device, a configuration for wake-up signal monitoring; determine, at least based on the configuration, a set of time-frequency resources unrelated to a paging occasion; and perform the wake-up signal monitoring at least based on the set of time-frequency resources.

In some embodiments, a network device comprises a circuitry configured to: transmit, at a network device, a set of configurations for wake-up signal monitoring of at least one set of terminal devices, a configuration in the set of configurations indicating a set of time-frequency resources unrelated to a paging occasion; and perform a wake-up signal transmission at least based on the set of time-frequency resources.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In summary, embodiments of the present disclosure may provide the following solutions.

In one solution, a method of communication comprises: determining, at a terminal device, whether to apply a low power mode during which a wake-up signal monitoring is performed; and performing, based on a determination of applying the low power mode, an operation associated with the low power mode.

In some embodiments, determining whether to apply the low power mode comprises: in accordance with a determination that a radio resource control release message comprising first information of the low power mode is received, determining to apply the low power mode.

In some embodiments, the first information of the low power mode comprises at least one of the following: an indication of the low power mode, a configuration for the low power mode, or a timer for the low power mode.

In some embodiments, determining whether to apply the low power mode comprises: in accordance with a determination that the radio resource control release message is received, starting a timer; and in accordance with a determination that the timer expires, determining to apply the low power mode.

In some embodiments, the method above further comprises: in accordance with a determination that a condition for cell re-selection is fulfilled while the timer is running and the terminal device supports mobility in the low power mode, restarting the timer; in accordance with a determination that the condition for cell re-selection is fulfilled while the timer is running and the terminal device does not support mobility in the low power mode, stopping the timer; in accordance with a determination that the terminal device enters a connected state and the timer is running, stopping the timer; in accordance with a determination that the terminal device performs a small data transmission procedure and the timer is running, restarting the timer; or in accordance with a determination that the terminal device receives a multicast and broadcast service and the timer is running, restarting the timer.

In some embodiments, determining whether to apply the low power mode comprises: receiving a paging message comprising second information of the low power mode, the second information indicating a set of identities of terminal devices; and in accordance with a determination that an identity in the set matches an identity of the terminal device, determining to apply the low power mode.

In some embodiments, the method above further comprises: receiving downlink control information scheduling reception of the paging message and only comprising an indication of the low power mode.

In some embodiments, determining whether to apply the low power mode comprises: receiving a paging message comprising a set of identities of terminal devices and a set of paging causes corresponding to the set of identities; in accordance with a determination that an identity in the set of identities matches an identity of the terminal device, determining whether a paging cause corresponding to the identity of the terminal device indicates the low power mode; and in accordance with a determination that the paging cause indicates the low power mode, determining to apply the low power mode.

In some embodiments, determining whether to apply the low power mode comprises: obtaining, from system information, information of a channel dedicated for notification of the low power mode; determining a set of occasions for monitoring the channel, the set of occasions being associated with a set of synchronization signal blocks; and in accordance with a determination that a message from the channel is received based on the set of occasions and the set of synchronization signal blocks and an identity comprised in the message matches an identity of the terminal device, determining to apply the low power mode.

In some embodiments, the information of the channel comprises at least one of the following: a length and offset of a repetition period for the channel; a starting slot of a transmission window for the channel; or a duration of the transmission window.

In some embodiments, determining the set of occasions comprises: determining, as the set of occasions, a set of candidate occasions that do not overlap with an uplink symbol based on a search space for the channel and the information of the channel; and determining a mapping between the set of occasions and the set of synchronization signal blocks based on an index of an occasion, an index of a synchronization signal block, the number of occasions in a transmission window and the number of actual transmitted synchronization signal blocks.

In some embodiments, the message comprises at least one of the following: a list of identities of terminal devices, or a configuration for the low power mode.

In some embodiments, determining whether to apply the low power mode comprises: receiving a configuration for the low power mode, the configuration comprising a set of measurement criteria; performing signal measurements based on the set of measurement criteria; and in accordance with a determination that the set of measurement criteria is fulfilled, determining to apply the low power mode.

In some embodiments, receiving the configuration for the low power mode comprises: receiving a radio resource control release message comprising the configuration for the low power mode; or receiving system information comprising the configuration for the low power mode.

In some embodiments, the set of measurement criteria comprises at least one of the following: a measurement criterion for a terminal device with low mobility, a measurement criterion for a terminal device with stationary, or a measurement criterion for a terminal device not at cell edge.

In some embodiments, performing the operation associated with the low power mode comprises at least one of the following: switching off main radio of the terminal device; switching on a wake-up signal receiver of the terminal device; indicating, from a lower layer to upper layers of the terminal device, a cause of applying the low power mode; stopping performing an operation in an idle or inactive state; applying a configuration for the low power mode; or performing a wake-up signal monitoring.

In another solution, a method of communication comprises: determining, at a terminal device, whether to apply a low power mode during which a wake-up signal monitoring is performed; and transmitting, based on a determination of applying the low power mode, a request for applying the low power mode.

In some embodiments, transmitting the request comprises: transmitting the request by assistance information; or transmitting the request by a random access procedure for the low power mode.

In some embodiments, transmitting the request by assistance information comprises: receiving a configuration for transmission of the assistance information; and transmitting the assistance information comprising at least one of the following: a preference on applying the low power mode, or a preference on a timer for the low power mode.

In some embodiments where the configuration for transmission of the assistance information comprises a further timer, the method above further comprises at least one of the following: in accordance with a determination that no assistance information is transmitted since reception of the configuration or in accordance with a determination that the assistance information is different from a previous assistance information indicated in a previous transmission of assistance information and the further timer is not running, starting the further timer; and initiating the transmission of the assistance information; or in accordance with a determination that the further timer is running, transmitting no further assistance information.

In some embodiments, transmitting the request by the random access procedure comprises: obtaining, from system information, a configuration for a contention-free random access resource for the request, the configuration comprising at least one of a preamble index used for the random access procedure or information of occasions for the random access procedure; selecting, from a set of random access preambles determined based on the preamble index, a random access preamble corresponding to a selected synchronization signal block; and performing a preamble transmission based on the random access preamble and the information of occasions.

In some embodiments, the method further comprises: in accordance with a determination that a random access response is received and the random access response comprises a medium access control sub-protocol data unit with a random access preamble identifier corresponding to the random access preamble, determining that reception of the random access response is successful; and in accordance with a determination that the random access response comprises a medium access control sub-protocol data unit with only a random access preamble identifier, performing an operation associated with the low power mode.

In some embodiments, transmitting the request by the random access procedure comprises: in accordance with a determination that a contention-based preamble is selected to perform the random access procedure, transmitting a message 3 by causing a message dedicated for the low power mode to be comprised in a service data unit for an uplink common control channel.

In some embodiments, the method above further comprises: in accordance with a determination that a contention resolution identity in a medium access control control element of a medium access control protocol data unit matches the service data unit, determining that contention resolution is successful; and performing an operation associated with the low power mode.

In some embodiments, the medium access control protocol data unit comprises a configuration for the low power mode.

In some embodiments, performing the operation associated with the low power mode comprises at least one of the following: switching off main radio of the terminal device; switching on a wake-up signal receiver of the terminal device; indicating, from a lower layer to upper layers of the terminal device, reception of an acknowledgement for the request; stopping performing an operation in an idle or inactive state; or performing a wake-up signal monitoring.

In some embodiments, the methods above further comprise: in accordance with a determination that a wake-up signal is received, performing an operation in an idle or inactive state; or in accordance with a determination that a wake-up signal is received, performing an operation in a connected state.

In some embodiments, performing the operation in the idle or inactive state comprises at least one of the following: stopping the wake-up signal monitoring; performing a cell selection procedure; or in accordance with a determination that the terminal device camps on a cell, monitoring at least one of a paging channel, a short message or system information from the cell.

In some embodiments, the methods above further comprises: in accordance with a determination that the short message is received, performing an operation associated with the short message; stopping the operation in the idle or inactive state; and performing the wake-up signal monitoring. In some embodiments, the methods above further comprises: in accordance with a determination that no identity comprised in the paging message matches an identity of the terminal device, stopping the operation in an idle or inactive state; and performing the wake-up signal monitoring.

In some embodiments, performing the operation in the connected state comprises at least one of the following: stopping the wake-up signal monitoring; performing a cell selection procedure; in accordance with a determination that the terminal device camps on a cell, monitoring system information from the cell; or initiating a random access procedure.

In another solution, a method of communication comprises: transmitting, at a network device, information of applying a low power mode during which a wake-up signal monitoring is performed.

In some embodiments, transmitting the information of applying the low power mode comprises: transmitting a radio resource control release message comprising first information of the low power mode.

In some embodiments, the first information of the low power mode comprises at least one of the following: an indication of the low power mode, a configuration for the low power mode, or a timer for the low power mode.

In some embodiments, transmitting the information of applying the low power mode comprises: transmitting a paging message comprising second information of the low power mode, the second information indicating a set of identities of terminal devices.

In some embodiments, the methods above further comprises: transmitting downlink control information scheduling reception of the paging message and only comprising an indication of the low power mode.

In some embodiments, transmitting the information of applying the low power mode comprises: transmitting a paging message comprising a set of identities of terminal devices and a set of paging causes corresponding to the set of identities, at least one paging cause in the set of paging causes indicating the low power mode.

In some embodiments, transmitting the information of applying the low power mode comprises: transmitting, in system information, information of a channel dedicated for notification of the low power mode; determining a set of occasions associated with the channel, the set of occasions being associated with a set of synchronization signal blocks; and transmitting a message based on the set of occasions and the set of synchronization signal blocks.

In some embodiments, the information of the channel comprises at least one of the following: a length and offset of a repetition period for the channel; a starting slot of a transmission window for the channel; or a duration of the transmission window.

In some embodiments, determining the set of occasions comprises: determining, as the set of occasions, a set of candidate occasions that do not overlap with an uplink symbol based on a search space for the channel and the information of the channel; and determining a mapping between the set of occasions and the set of synchronization signal blocks based on an index of an occasion, an index of a synchronization signal block, the number of occasions in a transmission window and the number of actual transmitted synchronization signal blocks.

In some embodiments, the message comprises at least one of the following: a list of identities of terminal devices, or a configuration for the low power mode.

In some embodiments, transmitting the information of applying the low power mode comprises: transmitting a configuration for the low power mode, the configuration comprising a set of measurement criteria.

In some embodiments, transmitting the configuration for the low power mode comprises: transmitting a radio resource control release message comprising the configuration for the low power mode; or transmitting system information comprising the configuration for the low power mode.

In some embodiments, the set of measurement criteria comprises at least one of the following: a measurement criterion for a terminal device with low mobility, a measurement criterion for a terminal device with stationary, or a measurement criterion for a terminal device not at cell edge.

In another solution, a method of communication comprises: receiving, at a network device, a request for applying a low power mode during which main radio of a terminal device is turned off and a wake-up signal receiver of the terminal device is turned on.

In some embodiments, receiving the request comprises: receiving the request by assistance information; or receiving the request by a random access procedure for the low power mode.

In some embodiments, receiving the request by assistance information comprises: transmitting a configuration for transmission of the assistance information; and receiving assistance information comprising at least one of the following: a preference on applying the low power mode, or a preference on a timer for the low power mode.

In some embodiments, the configuration for transmission of the assistance information comprises a further timer.

In some embodiments, the method above further comprises: transmitting, in system information, a configuration for a contention-free random access resource dedicated for the request, the configuration comprising at least one of a preamble index used for the random access procedure or information of occasions for the random access procedure.

In some embodiments, the method above further comprises: receiving a message 3 that comprises a message dedicated for the low power mode in a service data unit for an uplink common control channel.

In another solution, a device of communication comprises: a processor configured to cause the device to perform any of the methods above.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1A to 8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-20. (canceled)

21. A method performed by a terminal device, comprising:
receiving a lower-power wake-up signal (LPWUS) related configuration from system information, the LPWUS related configuration comprising information for LPWUS monitoring; and
in a case where a condition for LPWUS monitoring is fulfilled based on parameters in the information for LPWUS monitoring, performing the LPWUS monitoring.

22. The method of claim 21, further comprising: performing signal measurements based on the parameters in the information for LPWUS monitoring.

23. The method of claim 21, further comprising: in a case where a LPWUS is received, monitoring a paging occasion (PO).

24. The method of claim 21, further comprising: transmitting assistance information comprising at least one of the following:
a preference on applying a low power mode, or
a preference on a timer for the low power mode.

25. A terminal device, comprising a processor configured to:
receive a lower-power wake-up signal (LPWUS) related configuration from system information, the LPWUS related configuration comprising information for LPWUS monitoring; and
in a case where a condition for LPWUS monitoring is fulfilled based on parameters in the information for LPWUS monitoring, performing the LPWUS monitoring.

26. The terminal device of claim 25, wherein the processor is further configured to cause the terminal device to: perform signal measurements based on the parameters in the information for LPWUS monitoring.

27. The terminal device of claim 25, wherein the processor is further configured to cause the terminal device to: in a case where a LPWUS is received, monitor a paging occasion (PO).

28. The terminal device of claim 25, wherein the processor is further configured to cause the terminal device to: transmit assistance information comprising at least one of the following:
a preference on applying a low power mode, or
a preference on a timer for the low power mode.
